(19) United States
(12) Patent Application Publication
(10) Pub. No.: US 2019/0010062 A1
(43) Pub. Date: Jan. 10, 2019

(54) SYSTEMS AND METHODS FOR MONITORING SWIMMING POOL MAINTENANCE ACTIVITIES

(71) Applicant: Pool Agency, LLC, Phoenix, AZ (US)

(72) Inventors: Adam Beech, Phoenix, AZ (US); Michael Coulson, Surprise, AZ (US)

(73) Assignee: Pool Agency, LLC, Phoenix, AZ (US)

(21) Appl. No.: 15/992,741

(22) Filed: May 30, 2018

Related U.S. Application Data
(60) Provisional application No. 62/528,819, filed on Jul. 5, 2017.

(51) Int. Cl. C02F 1/00; H04Q 9/02; H04N 7/18; C02F 1/40; C02F 1/68; A46B 15/00; A47L 7/00; E04H 4/16; G07C 3/12

(52) U.S. Cl. CPC C02F 1/008; H04Q 9/02; H04N 7/185; C02F 1/40; C02F 1/68; A46B 15/0038; C02F 2103/42; E04H 4/16; G07C 3/12; H04Q 2209/40; C02F 2209/02; C02F 2209/006; A47L 7/0004

(57) ABSTRACT

The present disclosure includes systems and methods for monitoring swimming pool maintenance activities. A sensor assembly is mounted on one or more pool cleaning tools, such as a net or broom. The system can determine the type and duration of maintenance performed on the swimming pool.

### CROSS-REFERENCE TO RELATED APPLICATIONS

This application claims priority to, and the benefit of, U.S. Provisional Patent Application No. 62/528,819 filed on Jul. 5, 2017 and entitled “SYSTEMS AND METHODS FOR MONITORING POOL MAINTENANCE ACTIVITIES,” the entire contents of which are incorporated by reference herein for all purposes.

### FIELD

The present disclosure generally relates to monitoring of maintenance activities, and more particularly, to systems and methods for automatic electronic detection and monitoring of swimming pool maintenance activities.

### BACKGROUND

The proper maintenance of in-ground swimming pools requires diligent maintenance, including cleaning and water quality maintenance. Many owners rely on pool maintenance professionals to provide regular maintenance. However, it can be difficult to know if regular or proper maintenance has been performed, as, frequently, pool owners are not present during the maintenance activities and cannot verify that they are actually occurring.

Further, pool equipment may fail or malfunction, and it can be difficult to know if there is a problem until water quality is negatively impacted. Finally, environmental factors (such as weather) can cause negative impacts on pool water quality and health.

Therefore, systems and devices for automatically monitoring maintenance activities, along with water quality and health, may be beneficial in detecting potential issues before the issues cause a significant negative impact.

### SUMMARY

The present disclosure includes systems for monitoring pool maintenance activities comprising a tracking apparatus mounted to a pool maintenance tool and comprising an accelerometer, a gyrometer, a temperature sensor, a central processing unit, a battery, and a pair of water sensing electrodes; a base that wirelessly communicates with the tracking apparatus, and a software application that processes a motion data, a time data, a temperature data, and a water data received by the tracking apparatus to determine a task type and a duration of the task type, wherein the task type comprises at least one of brushing, skimming, and vacuuming. The base may comprise a smartphone, and the software application can be implemented on the smartphone. Further, the software application may an image data transmitted by the camera module and synchronizes the image data with at least one of the motion data, the time data, and the water data. The software application may also calculate a necessary addition of a pool treatment chemical comprising at least one of chlorine, cyanuric acid, muriatic acid, sodium bisulfate, sodium carbonate, calcium chloride, boric acid, and sodium chloride. The system can comprise a secondary sensor positioned remotely from the tracking apparatus and in wireless communication with the tracking apparatus. The secondary sensor may comprise a basket sensor or a moisture sensor. Further, the system can comprise a third sensor. The tracking apparatus may comprise a camera module, and the software application may process image data transmitted by the camera module and synchronizes the image data with at least one of the motion data, the time data, the temperature data, and the water data.

The present disclosure further includes a system for monitoring pool maintenance activities comprising a tracking apparatus mounted to a pool maintenance tool and comprising a central processing unit, a temperature sensor, a camera module, a battery, a pair of water sensing electrodes, and at least one of an accelerometer and a gyrometer, a secondary sensor, a smartphone in wireless communicates with the tracking apparatus and the secondary sensor, and a software application that processes a motion data, a time data, a temperature data, and a water data received by the tracking apparatus and a secondary data from the secondary sensor to determine a task and a duration of the task, wherein the task comprises at least one of brushing, skimming, and vacuuming. The software application can be implemented on the smartphone. Further, the software application may an image data transmitted by the camera module and synchronizes the image data with at least one of the motion data, the time data, the temperature data, and the water data. The software application may also calculate a necessary addition of a pool treatment chemical comprising at least one of chlorine, cyanuric acid, muriatic acid, sodium bisulfate, sodium carbonate, calcium chloride, boric acid, and sodium chloride. The system can comprise a secondary sensor positioned remotely from and in wireless communication with the tracking apparatus. The secondary sensor may comprise a basket sensor or a moisture sensor. Further, the system can comprise a third sensor. The tracking apparatus may comprise a camera module, and the software application may process image data transmitted by the camera module and synchronizes the image data with at least one of the motion data, the time data, the temperature data, and the water data.

The present disclosure includes pool maintenance tracking apparatus comprising a central processing unit, a camera module, a temperature sensor, a battery, a pair of water sensing electrodes, and at least one of an accelerometer and a gyrometer, a wireless module in wireless communication with a base, wherein the tracking apparatus transmits at least one of a motion data, a time data, a temperature data, and a water data to the base, and a mount for mounting the tracking apparatus to a pool maintenance tool. The tracking apparatus may further comprise a camera. Further, the wireless module may transmit an image data received by the camera module to the base. The central processing unit may synchronize the image data with at least one of the motion data, the time data, and the water data.

### BRIEF DESCRIPTION OF THE DRAWINGS

The features and advantages of the present disclosure will become more apparent from the detailed description set forth below when taken in conjunction with the drawings, wherein:

FIG. 1 illustrates a schematic diagram of a system for tracking swimming pool maintenance activities;

FIG. 2 illustrates an apparatus for tracking swimming pool maintenance activities in accordance with the present disclosure; and

FIG. 3 illustrates a flow chart depicting a method for tracking swimming pool maintenance activities in accordance with the present disclosure.

### DETAILED DESCRIPTION OF THE ILLUSTRATED EMBODIMENTS

Persons skilled in the art will readily appreciate that various aspects of the present disclosure can be realized by any number of methods and articles configured to perform the intended functions. Stated differently, other methods and articles can be incorporated herein to perform the intended functions. It should also be noted that the accompanying drawing figures referred to herein are not all drawn to scale, but may be exaggerated to illustrate various aspects of the present disclosure, and in that regard, the drawing figures should not be construed as limiting. Finally, although the present disclosure may be described in connection with various principles and beliefs, the present disclosure should not be bound by theory.

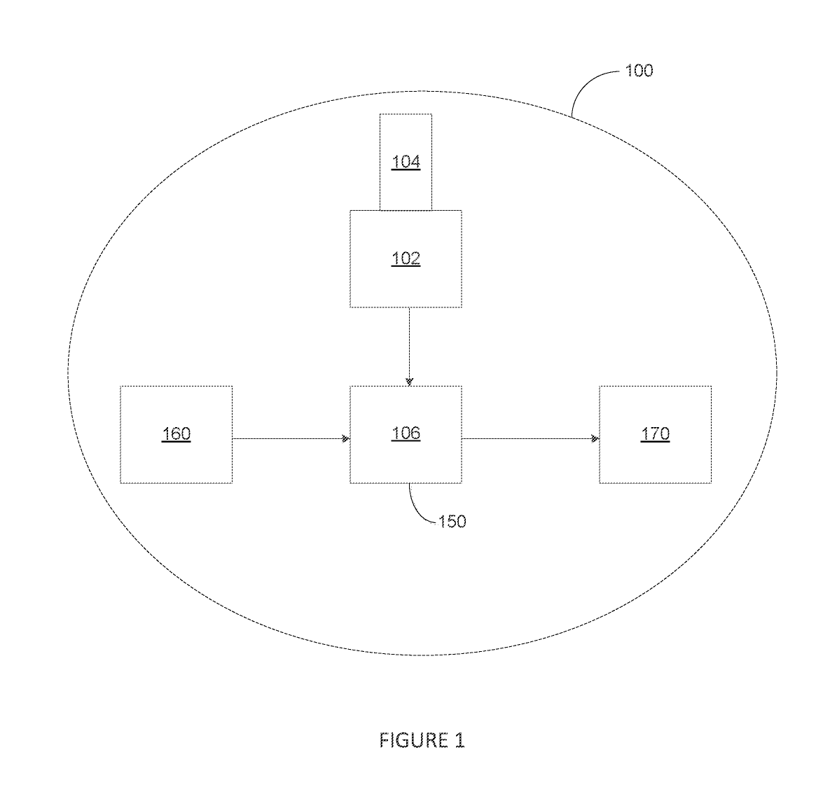

For example, with initial reference to FIG. 1, a tracking system 100 in accordance with the present disclosure comprises a tracking apparatus 102, a maintenance tool 104, and a base 106. In various embodiments, tracking apparatus 102 communicates wirelessly with base 106 to transmit data corresponding to the movement and usage of maintenance tool 104.

In various embodiments, maintenance tool 104 can comprise a pole coupled to a pole-mounted tool, such as a skimmer, net, brush, or vacuum. The pole-mounted tool can be removably coupled to the pole of maintenance tool 104. For example, multiple different types of pole-mounted tools can be removably coupled in the same manner to the pole of maintenance tool 104, such that a user can change between the various pole-mounted tools on the same pole. Maintenance tool 104 can be operated by an individual, such as a pool-cleaning professional, to perform maintenance activities on a body of water, such as a swimming pool. In various embodiments, maintenance tool 104 is utilized by an operator standing outside of the body of water and deploying the tool on the surface or within the body of water. Maintenance tool 104 can comprise any pole-mounted tool capable of performing a maintenance activity on a body of water, including brushing the sides or bottom of the body of water, vacuuming the bottom of the body of water, and/or skimming the surface of the body of water.

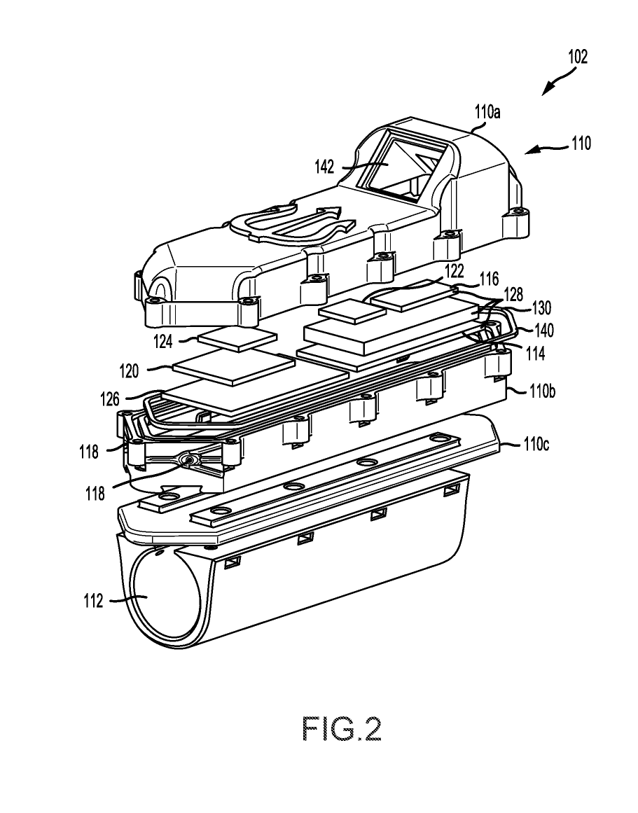

With reference to FIG. 2, tracking apparatus 102 can comprise, for example, a housing 110. In various embodiments, housing 110 is a water-resistant or waterproof housing that encloses most or all of tracking apparatus 102, allowing for submersion of the apparatus into, for example, a swimming pool. For example, housing 110 can comprise multiple segments affixed to each other removably, semi-permanently, or permanently. In various embodiments, housing 110 comprises a top segment 110a, and a bottom segment 110b. Segments of housing 110 can be insulated from water entry by one or more water-resistant or waterproof gaskets 140. For example, a waterproof gasket 140 can be positioned between bottom segment 110b and top segment 110a of housing 110. Any configuration of housing segments, including a single, unitary housing 110, is within the scope of the present disclosure.

In various embodiments, tracking apparatus 102 can comprise a mount 112. For example, mount 112 can removably, semi-permanently, or permanently couple tracking apparatus 102 to maintenance tool 104. In various embodiments, mount 112 is coupled to or integral to a segment of housing 110, such as bottom segment 110b. For example, mount 112 can be include a top plate 110c that is configured to couple to bottom segment 110b of housing 110. Mount 112 and/or top plate 110c can be removably, semi-permanently, or permanently coupled to housing 110.

Mount 112 can comprise a shape (such as, for example, a cylindrical shape) which conforms to a surface or segment of maintenance tool 104. For example, as illustrated in FIG. 2, mount 112 comprises a cylindrical shape integral to bottom segment 110b of housing 110. However, any manner of coupling, removably, semi-permanently, or permanently, tracking apparatus 102 to maintenance tool 104 is within the scope of the present disclosure.

Tracking apparatus 102 further comprises a central processing unit (“CPU”) 130. In various embodiments, CPU 130 is in electrical communication with sensors and other components of tracking apparatus 102. In that regard, CPU 130 may comprise one or more processors. Each processor in CPU 130 may be a general purpose processor, a digital signal processor (DSP), an application specific integrated circuit (ASIC), a field programmable gate array (FPGA) or other programmable logic device, discrete gate or transistor logic, discrete hardware components, or any combination thereof. CPU 130 can comprise, for example, an embedded computer system, such as a single board computer, a system on a chip, or a system in package. CPU 130 may comprise a tangible, non-transitory memory. CPU 130 may further comprise input/output (“I/O”) modules or related hardware that may provide a logical interface via a wireless (e.g., radio frequency mediated) or wired connection.

In other embodiments, CPU 130 comprises a computer-on-module system, comprising a computational module 128 and a carrier module 114. For example, computational module 128 can comprise a microprocessor and random access memory, and carrier module 114 can comprise a baseboard or carrier board to which computational model 128 is coupled.

In various embodiments, CPU 130 can operate in an active mode and a sleep or rest mode. For example, CPU 130 can operate in active mode as it is receiving data from one or more other components of tracking apparatus 102. If one more components of tracking apparatus 102 (such as, for example one or more sensors in communication with CPU 130) remain dormant for a specified period of time, CPU can enter a sleep or rest mode, wherein the CPU uses a reduced level of power. Further, CPU 130 can exit sleep or rest mode and enter active mode upon receipt of one or more signals from other components of tracking apparatus 102 (such as, for example, one or more sensors).

In various embodiments, tracking apparatus 102 further comprises a wireless module 116 in electronic communication with CPU 130 capable of transmitting data from tracking apparatus 102 to base 106. In that regard, wireless module 116 may be considered a I/O hardware. In various embodiments, wireless module 116 allows data to be transferred between wireless module 116 and external devices. Examples of wireless module 116 may include a wireless Ethernet network (e.g., an ad hoc network utilizing IEEE 802.11a/b/g/n/ac), a wireless communications protocol using short wavelength UHF radio waves and defined at least in part by IEEE 802.15.1 (e.g., the BLUETOOTH protocol maintained by Bluetooth Special Interest Group), a low power wireless protocol such as Bluetooth Smart, inductive coupling, near field communication (NFC), or other protocol having a physical link comprising radio frequency (RF) signals. Communications interfaces may also include data transmission protocols such as transmission control protocol (“TCP”) and Internet Protocol (“IP”).

Wireless module 116 can any other module capable of transmitting data from tracking apparatus 102 to a compatible receiver (e.g., base 106) wirelessly.

Tracking apparatus 102 further comprises a battery 120. In various embodiments, battery 120 comprises a rechargeable battery that provides electrical power to the other components of tracking apparatus 102, such as CPU 130 and wireless module 116. For example, battery 120 can comprise a lithium polymer battery, a nickel-cadmium or nickel-metal hydride battery, a lead-acid battery, or any other type of rechargeable battery.

In various embodiments, tracking apparatus 102 comprises one or more charging modules coupled to battery 120 and capable of providing electrical charge to battery 120. For example, a charging module 126 can comprise a direct current charging module. In such embodiments, battery 120 can be charged by applying current from an alternating current source (such as, for example, a 120 volt wall socket) through direct current charging module 126 (e.g., by plugging in a direct current adapter to tracking apparatus 102 and a wall socket). Charging module 126 can also comprise an inductive charging module. In such embodiments, battery 120 can be charged through inductive charging module 126 by placing tracking apparatus 102 at or sufficiently close to an inductive charger. Further, tracking apparatus 102 can comprise both a direct current charging module and an inductive charging module. In other embodiments, tracking apparatus 102 comprises one of a direct current charging module and an inductive charging module.

Tracking apparatus 102 further comprises one or more motion sensing components 122 in electronic communication with central processing unit 130. In various embodiments, motion-sensing component 122 comprises an accelerometer and/or a gyrometer. For example, tracking apparatus 102 can comprise two motion-sensing components 122, wherein one is an accelerometer and one is a gyrometer. Although described with reference to specific motion-sensing components, any electronic component capable of sensing and measuring motion and transmitting data to central processing unit 130 is within the scope of the present disclosure.

In various embodiments, tracking apparatus 102 comprises one or more water-sensing electrodes 118. For example, tracking apparatus 102 can comprise a pair of water-sensing electrodes 118. In various embodiments, water-sensing electrodes 118 can detect when housing 110 of tracking apparatus 102 is submerged or otherwise exposed to water. Once submerged, water-sensing electrodes 118 can send a signal to CPU 130, causing it to enter an active mode and begin storing and/or processing data from other components of tracking apparatus 102.

Tracking 102 apparatus can further comprise, for example, a temperature sensor 124. In various embodiments, temperature sensor 124 captures and transmits a temperature data to CPU 130 of tracking apparatus 102. Temperature sensor 124 can comprise a discreet temperature sensor, or a sensor that is integral to a component of tracking apparatus 102. However, any temperature sensor capable of capturing temperature data and transmitting the data to CPU 130 of tracking apparatus 102 is within the scope of the present disclosure.

Tracking apparatus 102 can further comprise, for example, a camera module 142. In various embodiments, camera module 142 captures images and/or video during operation of maintenance tool 104 (to which tracking apparatus 102 is coupled). Camera module 142 transmits image data to CPU 130 of tracking apparatus 102.

With reference back to FIG. 1, tracking apparatus 102 communicates with base 106 of system 100. In various embodiments, wireless module 116 of tracking apparatus 102 transmits data from tracking apparatus 102 to base 106. In various embodiments, base 106 comprises a computer-based platform configured to receive data from tracking apparatus 102. For example, base 106 can comprise a smartphone, tablet, or other mobile computing device capable of receiving wirelessly transmitted data from tracking apparatus 102.

In various embodiments, base 106 can comprise a stationary (i.e., non-mobile) computing device. For example, base 106 can comprise a home computer (such as a desktop computer). In other embodiments, base 106 can comprise a wireless router attached to the internet. For example, base 106 can comprise a wireless router that transmits data received from system 100 to a remote-located computer (such as a server). Although described with reference to specific types of computer-based systems, base 106 can comprise any system capable of receiving data from other components of system 100.

In various embodiments, base 106 comprises a software application 150. For example, software application 150 can receive data from tracking apparatus 102 and process the data. In various embodiments, tracking apparatus 102 transmits one or more of a motion data, a time data, a temperature data, and a water data to base 106, which is received and processed by software application 150.

Software application 150 receives data from tracking apparatus 102 and, for example, can process the data to determine if a maintenance activity has occurred. For example, software application 150 can utilize the motion data and the time data to determine if the pool maintenance tool 104, to which tracking apparatus 102 is coupled, has moved in one or more dimensions during a particular timeframe. If maintenance tool 104 has moved during the specified timeframe, software application 150 can process the motion data and time data to determine what types of maintenance activities have occurred during the timeframe. For example, maintenance tool 104 may have been used, during the timeframe, to conduct a brushing activity, a skimming activity, and/or a vacuuming activity, among other maintenance activities.

Software application 150 can, for example, determine the duration of one or more maintenance activities. In various embodiments, software application processes the data transmitted by CPU 130 of tracking apparatus 102 to determine both a type and duration of a maintenance activity.

In various embodiments, software application 150 can process image data captured by camera module 142 and transmitted by CPU 130. For example, software application 150 can synchronize image data captured by camera module 142 motion data and/or time data corresponding to one or more particular maintenance activities performed by maintenance tool 104. For example, if software application 150 determines that a particular maintenance activity (e.g., brushing) occurred during a specific time period, software application 150 can associate the image data captured during the performance of the maintenance activity with the specific time that the activity occurred during, producing a video or collection of images corresponding with the maintenance activity. In various embodiments, multiple different maintenance activities are performed during a particular time period, and software application 150 can associate different videos and/or collections of images with each of the corresponding maintenance activities.

Software application 150 can, for example, process chemical composition and/or concentration data (e.g., chemical data) received from CPU 130 of tracking apparatus 102. In various embodiments, a user obtains the chemical data by testing the water via test strips, test solutions, test solution mixtures, and any other suitable chemical testing method. The user then inputs the information to software application 150. In various embodiments, software application 150 determines the stability and/or health of a body of water (e.g., a swimming pool) by processing the chemical composition and/or concentration data. For example, software application 150 can, using the chemical composition and/or concentration data (e.g., water data), determine one or more of a pH level, a chlorine concentration, an alkalinity level, and a calcium hardness level of the body of water, and compare these levels to appropriate levels required for the stability and/or health of the water.

In various embodiments, software application 150 can determine, based on the chemical composition and/or concentration data, if one or more chemical constituents should be added to the body of water. Such potential chemical constituents include chlorine, cyanuric acid, muriatic acid, sodium bisulfate, sodium carbonate, calcium chloride, boric acid, and sodium chloride. Further, software application 150 can determine the appropriate amount of chemical necessary to restore stability and/or health to the body of water.

Software application 150 may be implemented, for example, by a computer-based system in communication with base 106. For example, base 106 can comprise a router or other internet-connected device that transmits data received from other components of system 100 to a remote-located computer. In such embodiments, software application 150 is implemented by the remote-located computer (such as, for example, one or more servers), and not by base 106. However, any manner of implementing software application 150 to receive and process data from system 100 is within the scope of the present disclosure.

In various embodiments, software application 150 can represent and visually display information via a graphic user interface. For example, software application 150 can provide visual representation of data such as chemical composition and/or concentrations, type and duration of maintenance tasks performed, video and images of specific maintenance tasks performed, and/or recommended chemical treatments. Any data or information processed or generated by software application 150 can be displayed to the user via a graphical user interface.

Software application 150 can, for example, transmit alerts and reminders to one or more users. For example, an alert or reminder corresponding to data processed or information generated by software application 150 can be provided to a person or entity responsible for maintenance of a pool in which system 100 is utilized, including a pool monitoring service or a pool owner, for example. In various embodiments, such reminders and alerts can comprise notification that a particular maintenance activity is scheduled, is occurring, or has occurred. Further, data about the stability and health, including the chemical composition of the body of water at a specific time, can be sent as alerts or reminders to users.

System 100 can further comprise additional sensors in wireless communication with tracking apparatus 102. For example, system 100 can include one or more of a basket sensor 160. Basket sensor 160 can comprise a sensor affixed to a filtration pump basket, skimmer basket, or other pump basket, and capable of detecting removal and/or emptying of the basket and transmitting a basket data to tracking apparatus 102. For example, basket sensor 160 can comprise a mercury tilt switch sensor which sends a signal to tracking apparatus 102 when its state changes from closed to open (or vice versa), indicating that the filter basket has been emptied. However, any type of sensor capable of detecting emptying of a filter basket is within the scope of the present disclosure.

In various embodiments, system 100 comprises one or more moisture sensors 170. For example, moisture sensor 170 can be positioned after a backflow valve of a pool filter system. In such embodiments, moisture sensor 170 can detect water flowing out of the backflow valve, thereby detecting that the pool filter system has been back flushed. However, one or more moisture sensors 170 can be positioned at any suitable point in a pool system. For example, moisture sensor 170 can be positioned at or near a fill valve, thereby detecting and measuring the amount of water added to a body of water during a particular time frame. Such data can, for example, anticipate or detect a source of water leakage within the system. Moisture sensor 170 can comprise any sensor capable of measuring a flow of water and transmitting flow data to tracking apparatus 102.

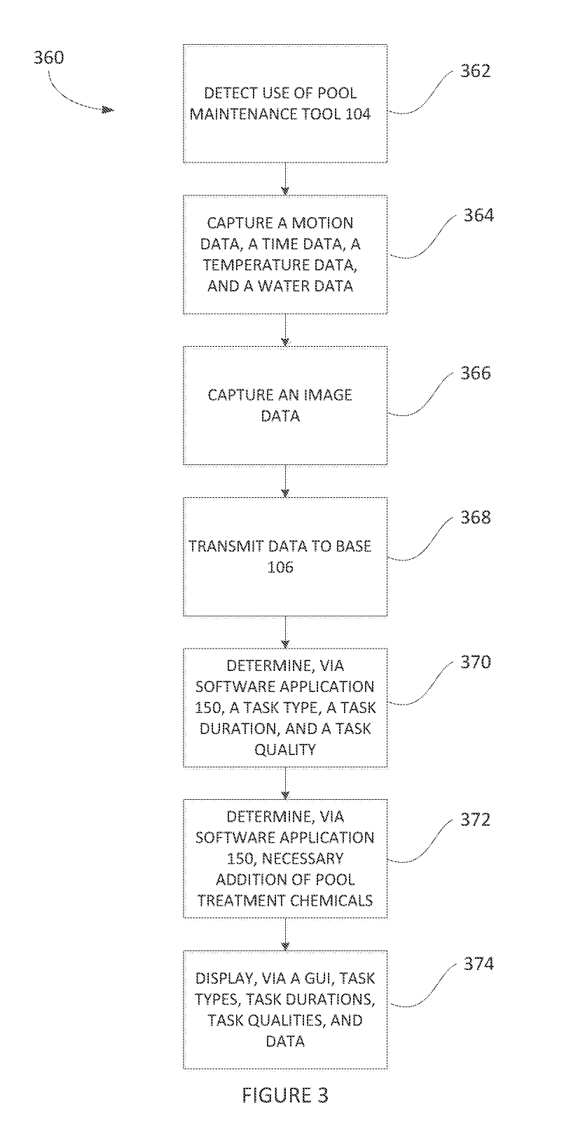

With reference to FIG. 3, a method 360 for monitoring pool maintenance activities in accordance with the present disclosure is illustrated. Method 360 can comprise, for example, a detect use of pool maintenance tool step 362. In various embodiments, tracking apparatus 102 detects the use of pool maintenance tool 104 by one or more of its sensors. For example, step 362 can comprise detecting motion by motion sensing component 122, or detecting submersion of pool maintenance tool 104 within a pool by water-sensing electrodes 118.

Further, method 360 can comprise a capture data step 364. For example, step 364 can comprise capturing a motion data, a time data, a temperature data, and/or a water data from the pool in which tracking apparatus 102 is deployed. As previously described, the various sensors of tracking apparatus 102 (e.g., motion sensing components 122, water-sensing electrodes 118, and temperature sensor 124) can collect data as pool maintenance tool 104 to which tracking apparatus 102 is coupled is utilized.

Method 360 can further comprise, for example, a capture an image data step 366. In various embodiments, tracking apparatus 102 comprises an camera module (such as camera module 142) which is capable of capturing image data as pool maintenance tool 104 (to which tracking apparatus 102 is coupled) is deployed with a pool.

In various embodiments, method 360 further comprises a transmit data step 368. For example, step 366 can comprise transmitting the data captured by tracking apparatus 102 (e.g., motion data, time data, temperature data, water data, and/or image data) via wireless module 116 to base 106.

Method 360 can further comprise, for example, a step 370 of determining, via software application, a task type, a task duration, and a task quality. For example, step 370 comprises processing the motion data, time data, temperature data, water data, and/or image data to determine which maintenance tasks have been performed. Further, the captured data is processed to determine how long each of the maintenance tasks were performed. In various embodiments, the data captured by tracking apparatus 102 can be compared to reference data for one or more of the performed maintenance tasks, for the purpose of determining the quality of the tasks performed. For example, the captured data can be processed to determine that a brushing type task has occurred, and system 100 can compare the captured data corresponding to the brushing type task to reference data corresponding to a “high” quality brushing task type. The brushing task can then be classified as, for example, a “low,” “medium,” or “high” quality task, depending on how closely the captured data corresponds with the reference data for the task type.

In various embodiments, method 360 further comprises a determine necessary pool treatment chemicals step 372. For example, step 372 can comprise the user testing a sample of water from the pool via one or more of a test strip, a test solution, a mixture of test solutions, or any other suitable water chemical testing method, to determine a chemical data. The user then provides the chemical data to software application 150, which calculates a necessary pool treatment chemical addition, and the corresponding amount of chemical addition needed.

Further, method 372 can comprise a display task information step 374. For example, step 374 can comprise displaying task types, task durations, and/or task qualities, as well as captured data, to a user via a graphical user interface (“GUI”).

In the present disclosure, the words “a” or “an” are to be taken to include both the singular and the plural. Conversely, any reference to plural items shall include, where appropriate, the singular.

Numerous characteristics and advantages have been set forth in the preceding description, including various alternatives together with details of the structure and function of the devices and/or methods. The disclosure is intended as illustrative only and as such is not intended to be exhaustive. It will be evident to those skilled in the art that various modifications may be made, especially in matters of structure, materials, elements, components, shape, size, and arrangement of parts including combinations within the principles of the invention, to the full extent indicated by the broad, general meaning of the terms in which the appended claims are expressed. To the extent that these various modifications do not depart from the spirit and scope of the appended claims, they are intended to be encompassed therein.

We claim:

1. A system for monitoring pool maintenance activities comprising:
a tracking apparatus mounted to a pool maintenance tool and comprising an accelerometer, a gyrometer, a temperature sensor, a central processing unit, a battery, and a pair of water sensing electrodes;
a base that wirelessly communicates with the tracking apparatus;
a software application that processes a motion data, a time data, a temperature data, and a water data received by the tracking apparatus to determine a task type and a duration of the task type, wherein the task type comprises at least one of brushing, skimming, and vacuuming.

2. The system of claim 1, wherein the base is a smartphone, and the software application is implemented on the smartphone.

3. The system of claim 1, further comprising a secondary sensor positioned remotely from the tracking apparatus and in wireless communication with the tracking apparatus.

4. The system of claim 3, wherein the secondary sensor comprises a basket sensor mounted on a filter basket, and the software application processes a filter basket data from the basket sensor and determines an emptied state for the filter basket.

5. The system of claim 3, wherein the secondary sensor comprises a moisture sensor positioned at or near a backflow valve.

6. The system of claim 1, wherein the tracking apparatus further comprises a camera module.

7. The system of claim 6, wherein the software application processes an image data transmitted by the camera module and synchronizes the image data with at least one of the motion data, the time data, and the water data.

8. The system of claim 3, further comprising a third sensor in wireless communication with the tracking apparatus.

9. The system of claim 1, wherein the software application determines a quality level of the task type.

10. The system of claim 9, wherein the software application calculates a necessary addition of a pool treatment chemical comprising at least one of chlorine, cyanuric acid, muriatic acid, sodium bisulfate, sodium carbonate, calcium chloride, boric acid, and sodium chloride.

11. A system for detecting pool maintenance activities comprising:
a tracking apparatus mounted to a pool maintenance tool and comprising a central processing unit, a camera module, a battery, a temperature sensor, a pair of water sensing electrodes, and at least one of an accelerometer and a gyrometer;
a secondary sensor in wireless communication with the tracking apparatus;
a smartphone in wireless communicates with the tracking apparatus;
a software application that processes a motion data, a time data, a temperature data, and a water data received by the tracking apparatus and a secondary data from the secondary sensor to determine a task and a duration of the task, wherein the task comprises at least one of brushing, skimming, and vacuuming.

12. The system of claim 11, wherein the secondary sensor comprises at least one of a basket sensor mounted on a basket and a moisture sensor mounted near a backflow valve.

13. The system of claim 11, further comprising a third sensor in wireless communication with the tracking apparatus.

14. The system of claim 13, wherein the third sensor comprises a moisture sensor mounted near a backflow valve.

15. The system of claim 11, wherein the software application processes an image data transmitted by the camera module and synchronizes the image data with at least one of the motion data, the time data, and the water data.

16. A pool maintenance tracking apparatus comprising:
a central processing unit, a camera module, a battery, a pair of water sensing electrodes, a temperature sensor, and at least one of an accelerometer and a gyrometer;
a wireless module in wireless communication with a base, wherein the tracking apparatus transmits at least one of a motion data, a time data, a temperature data, and a water data to the base; and
a mount for mounting the tracking apparatus to a pool maintenance tool.

17. The tracking apparatus of claim 16, further comprising a camera.

18. The tracking apparatus of claim 17, wherein the wireless module transmits an image data received by the camera module to the base.

19. The tracking apparatus of claim 18, wherein the central processing unit synchronizes the image data with at least one of the motion data, the time data, and the water data.

20. The tracking apparatus of claim 16, wherein the software application determines a quality level of the task type.
